(19) United States
(12) Patent Application Publication
(10) Pub. No.: US 2016/0328645 A1
(43) Pub. Date: Nov. 10, 2016

(54) REDUCED COMPUTATIONAL COMPLEXITY FOR FIXED POINT NEURAL NETWORK

(71) Applicant: QUALCOMM Incorporated, San Diego, CA (US)

(72) Inventors: Dexu LIN, San Diego, CA (US); Matthew BADIN, Santa Clara, CA (US); David Edward HOWARD, San Diego, CA (US); Daniel Hendricus Franciscus DIJKMAN, Haarlem (NL); Michael Colin TREMAINE, San Diego, CA (US); Anthony SARAH, San Diego, CA (US)

(21) Appl. No.: 14/882,351

(22) Filed: Oct. 13, 2015

Related U.S. Application Data
(60) Provisional application No. 62/159,106, filed on May 8, 2015.

(51) Int. Cl. G06N 3/08; G06N 99/00

(52) U.S. Cl. CPC G06N 3/08; G06N 99/005

(57) ABSTRACT

A method of reducing computational complexity for a fixed point neural network operating in a system having a limited bit width in a multiplier-accumulator (MAC) includes reducing a number of bit shift operations when computing activations in the fixed point neural network. The method also includes balancing an amount of quantization error and an overflow error when computing activations in the fixed point neural network.

### CROSS-REFERENCE TO RELATED APPLICATION

The present application claims the benefit of U.S. Provisional Patent Application No. 62/159,106, filed on May 8, 2015 and titled “REDUCED COMPUTATIONAL COMPLEXITY FOR FIXED POINT NEURAL NETWORKS,” the disclosure of which is expressly incorporated by reference herein in its entirety.

### BACKGROUND

1. Field

Certain aspects of the present disclosure generally relate to machine learning and, more particularly, to improving systems and methods of reducing computational complexity for a fixed point neural network operating in a system having a limited bit width.

2. Background

An artificial neural network, which may comprise an interconnected group of artificial neurons (e.g., neuron models), is a computational device or represents a method to be performed by a computational device.

Convolutional neural networks are a type of feed-forward artificial neural network. Convolutional neural networks may include collections of neurons that each have a receptive field and that collectively tile an input space. Convolutional neural networks (CNNs) have numerous applications. In particular, CNNs have broadly been used in the area of pattern recognition and classification.

Deep learning architectures, such as deep belief networks and deep convolutional networks, are layered neural networks architectures in which the output of a first layer of neurons becomes an input to a second layer of neurons, the output of a second layer of neurons becomes and input to a third layer of neurons, and so on. Deep neural networks may be trained to recognize a hierarchy of features and so they have increasingly been used in object recognition applications. Like convolutional neural networks, computation in these deep learning architectures may be distributed over a population of processing nodes, which may be configured in one or more computational chains. These multi-layered architectures may be trained one layer at a time and may be fine-tuned using back propagation.

Other models are also available for object recognition. For example, support vector machines (SVMs) are learning tools that can be applied for classification. Support vector machines include a separating hyperplane (e.g., decision boundary) that categorizes data. The hyperplane is defined by supervised learning. A desired hyperplane increases the margin of the training data. In other words, the hyperplane should have the greatest minimum distance to the training examples.

Although these solutions achieve excellent results on a number of classification benchmarks, their computational complexity can be prohibitively high. Additionally, training of the models may be challenging.

### SUMMARY

In one aspect of the present disclosure, a method of reducing computational complexity for a fixed point neural network operating in a system having a limited bit width in a multiplier-accumulator (MAC) is disclosed. The method includes reducing a number of bit shift operations when computing activations in the fixed point neural network. The method also includes balancing an amount of quantization error and an overflow error when computing activations in the fixed point neural network.

Another aspect of the present disclosure is directed to an apparatus including means for reducing a number of bit shift operations when computing activations in the fixed point neural network. The apparatus also includes means for balancing an amount of quantization error and an overflow error when computing activations in the fixed point neural network.

In another aspect of the present disclosure, a non-transitory computer-readable medium with non-transitory program code recorded thereon is disclosed. The program code for reducing computational complexity for a fixed point neural network operating in a system having a limited bit width in a multiplier-accumulator is executed by a processor and includes program code to reduce a number of bit shift operations when computing activations in the fixed point neural network. The program code also includes program code to balance an amount of quantization error and an overflow error when computing activations in the fixed point neural network.

Another aspect of the present disclosure is directed to an apparatus for reducing computational complexity for a fixed point neural network operating in a system having a limited bit width in a multiplier-accumulator. The apparatus having a memory unit and one or more processors coupled to the memory. The processor(s) is configured to reduce a number of bit shift operations when computing activations in the fixed point neural network. The processor(s) is also configured to balance an amount of quantization error and an overflow error when computing activations in the fixed point neural network.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIGS. 4 and 5 illustrate examples for extracting a number of bits from a multiplier-accumulator output in conventional systems.

FIGS. 6 and 7A-7C illustrate examples for extracting a number of bits from a multiplier-accumulator output according to aspects of the present disclosure.

FIGS. 8 and 9 illustrate methods for feature extraction according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth.

It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In some cases, a fixed point representation of a network, such as an artificial neural network (ANN), may lose precision during intermediate steps of computing new activations. The precision degradation may be mitigated when the multiplier-accumulator (MAC) has a bit width large enough to carry out the computation without loss, such that bits may be rounded off when the computation is done.

Still, the memory usage associated with storing and retrieving intermediate results may be increased when the multiplier-accumulator bit width is high. Thus, it may be desirable to limit the multiplier-accumulator bit width to simplify hardware and/or software implementations. Aspects of the disclosure are directed to improving fixed point computations with multiplier-accumulator bit width constraints.

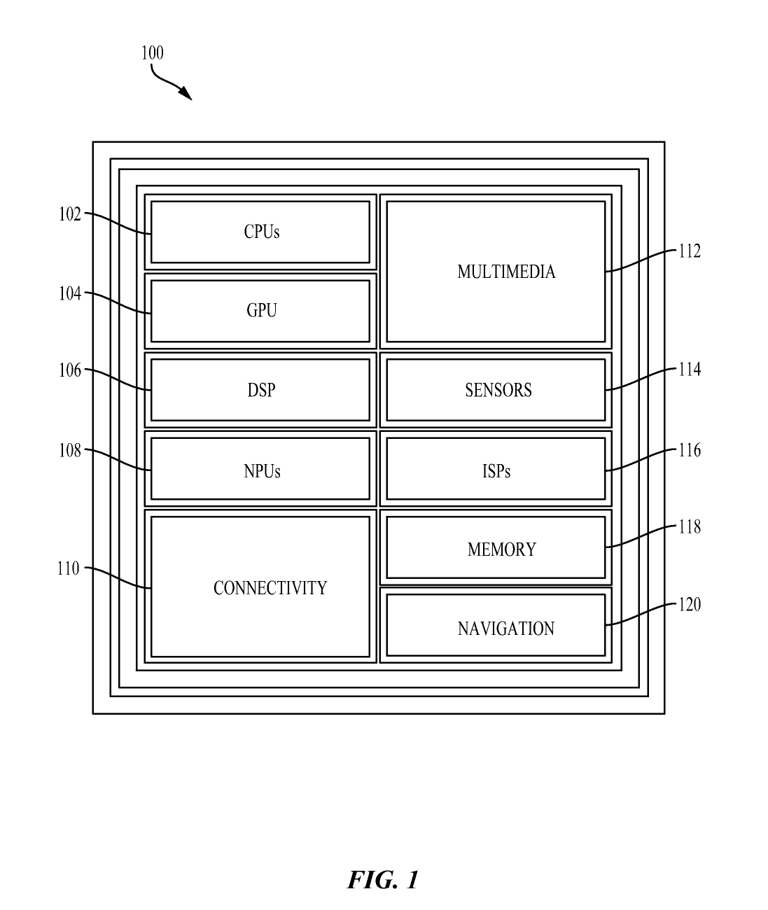

FIG. 1 illustrates an example implementation of the aforementioned reduction of computation complexity for a fixed point neural network operating in a system having a limited bit width in a multiplier-accumulator using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may comprise code for reducing a number of bit shift operations when computing activations in the fixed point neural network. The instructions loaded into the general-purpose processor 102 may also comprise code for balancing an amount of quantization error and an overflow error when computing activations in the fixed point neural network.

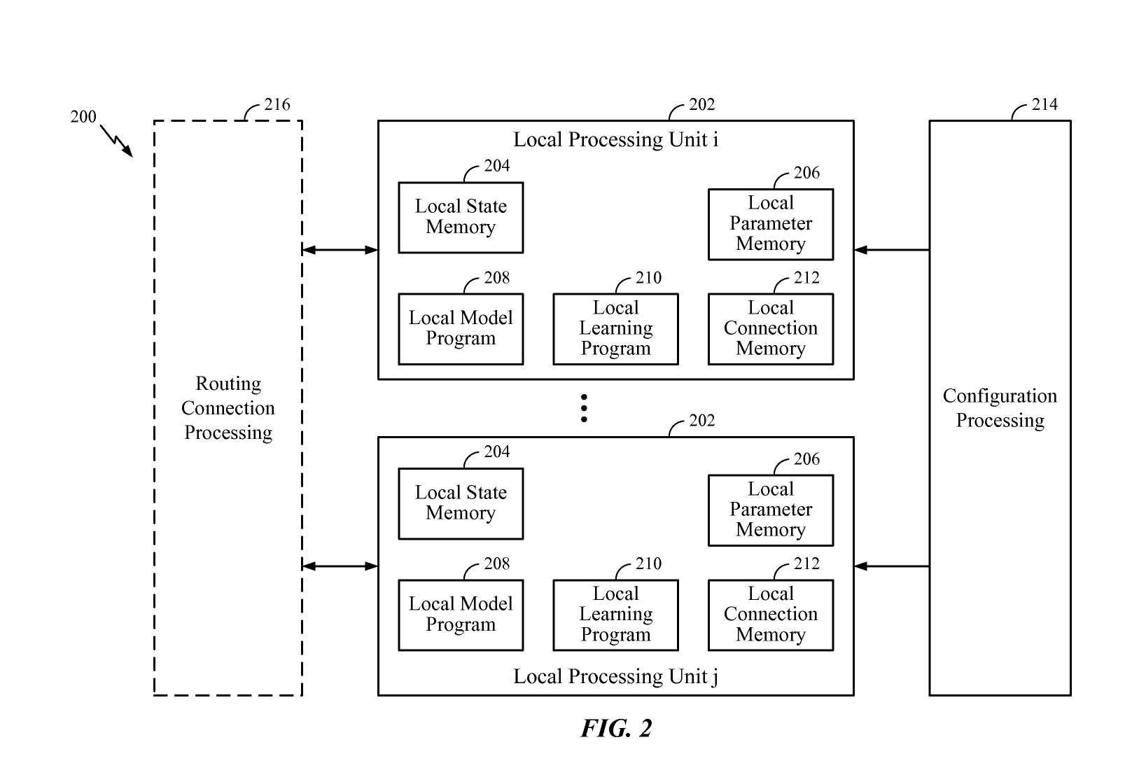

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high level concept may aid in discriminating the particular low-level features of an input.

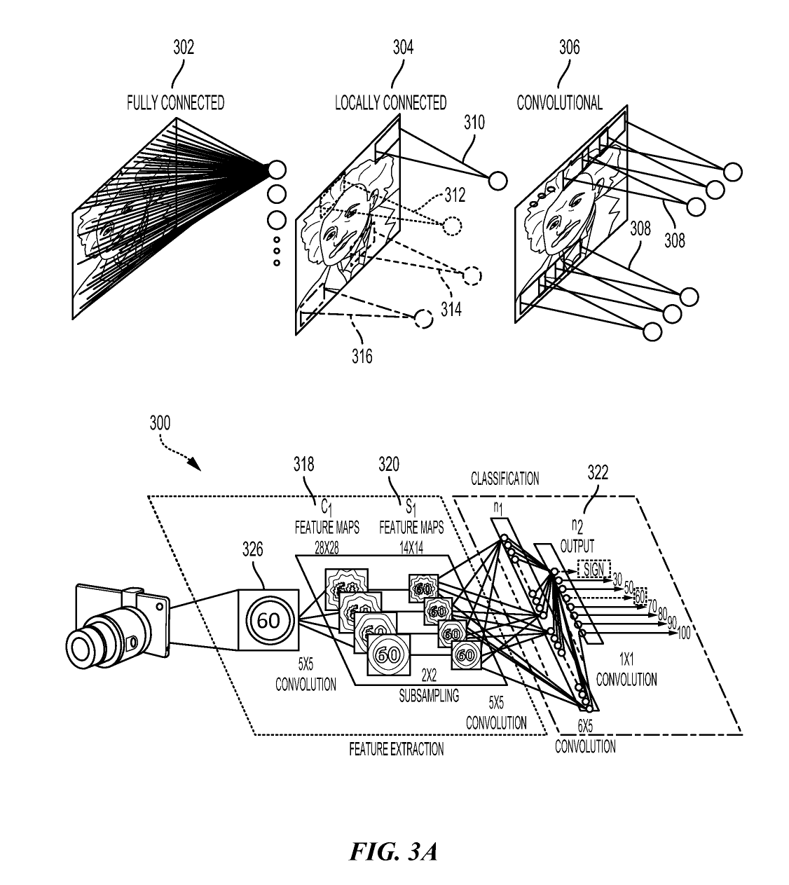

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A DCN may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

In one configuration, a machine learning model, such as a neural model, is configured for reducing a number of bit shift operations when computing activations in the network and balancing a quantization error and an overflow error when computing activations in the network. The model includes a reducing means and/or balancing means. In one aspect, the reducing means and/or balancing means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the model based upon desired one or more functional features of the model, and develop the one or more functional features towards the desired functional features as the determined parameters are further adapted, tuned and updated.

### Reduced Computational Complexity for Fixed Point Neural Network

In some cases, a fixed point representation of a network, such as a deep convolutional network (DCN) or an artificial neural network (ANN), may lose precision during the intermediate steps of computing new activations. In conventional systems, the loss of precision may be mitigated by increasing the bit width of a multiplier-accumulator, such as a multiplier-accumulator, to perform the computation. The increased bit width may also be specified to round off bits after performing the computation.

Still, increasing the multiplier-accumulator bit width may increase the complexity of hardware and/or software implementations. Furthermore, the increased multiplier-accumulator bit width may increase memory usage, such as the memory used for storing and retrieving intermediate results. Therefore, it is desirable to limit the size of the multiplier-accumulator bit width to reduce hardware complexity, reduce software complexity, and/or reduce memory usage. Accordingly, aspects of the disclosure are directed to improving fixed point computations with multiplier-accumulator bit width constraints.

Aspects of the disclosure are directed to using the Q number format. Still, other formats may be considered. The Q number format is represented as Qm.n, where m is a number of bits for an integer part and n is a number of bits for a fraction. In one configuration, m does not include a sign bit. Each Qm.n format may use an m+n+1 bit signed integer container with n fractional bits. In one configuration, the range is [−(2^{m}), 2^{m}−2⁻ⁿ)] and the resolution is 2⁻ⁿ. For example, a Q14.1 format number may use sixteen bits. In this example, the range is [−2¹⁴, 2¹⁴−2⁻¹] (e.g., −16384.0, +16383.5]) and the resolution is 2 (e.g., 0.5).

In one configuration, an extension of the Q number format is specified to support instances where the resolution is greater than one or the maximum range is less than one. In some cases, a negative number of fractional bits may be specified for a resolution greater than one. Additionally, a negative number of integer bits may be specified for a maximum range less than one.

In a network, such as an artificial neural network, with multiple layers, computation of the ith activation in layer l+1, aᵢ^{(l+1)}, may be expressed as follows:

aᵢ^{(l+1)}=Σⱼ₌₁^{N}w_{i,j}^{(l+1)}aⱼ^{(l)}+bᵢ^{(l+1)} (1)

In EQUATION 1, (l) represents the lth layer, N represents number of additions, w_{i,j} represents the weight between neuron j in layer l and neuron i in layer l, and bᵢ represents the bias to neuron i in layer l. Furthermore, aⱼ^{(l)} is the input activation.

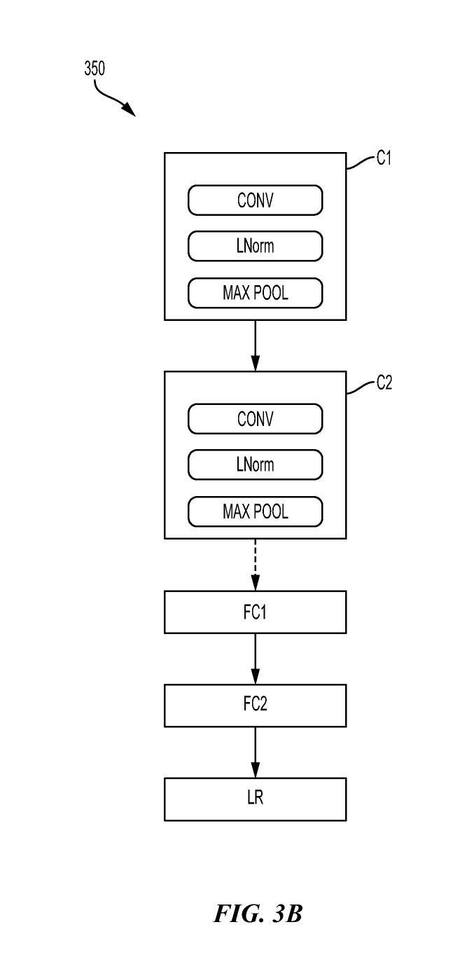

FIG. 4 illustrates an example for extracting 16 bits from the multiplier accumulator output in a conventional system. As previously discussed, the ith activation in layer l+1 may be determined based on EQUATION 1. As shown in EQUATION 1, for each neuron j the activation is the calculated by adding a product w_{i,j}aⱼ with a bias bᵢ.

In some cases, a 16 bit fixed point representation may be adopted. In an exemplary multiplier-accumulator implementation, N may be specified to equal 1000 and w_{i,j}aⱼ may be represented with 32 bits (31 bits+sign bit). Thus, lossless representation of the filter output may be achieved with multiplier-accumulator bit width of 42 bits (e.g., 32+log 2(1000)).

Therefore, in the present example, as shown in FIG. 4, a product w_{i,j}aⱼ 402 is represented using 32 bits with format Q8.23. That is, eight bits are specified for the integer and twenty-three bits are specified for the fraction, and one bit is specified for the sign. In the present example, the weight w_{i,j} may be of format Q4.11 and the input activation aⱼ may be of format Q3.12.

Furthermore, in the present example, the multiplier-accumulator 404 is specified to store the sum of the products w_{i,j} aⱼ, from j=1 to 1000 (e.g., N). Thus, as previously discussed, for lossless representation when storing the sum of the products, the multiplier-accumulator is specified a bit width of 42 bits. The increased bit width of the multiplier-accumulator also mitigates an overflow and/or a quantization error. FIG. 4 illustrates an example of the 42 bit multiplier-accumulator 404.

Additionally, in conventional systems, after determining the sum of the products and storing the sum in the increased bit width multiplier-accumulator, a number of bits are removed for the final representation of the sum. For example, as shown in FIG. 4, after determining and storing the sum of products in the multiplier-accumulator 404, a 16 bit output 406 is produced by rounding off seventeen least significant bits (LSBs) and removing nine most significant bits (MSBs) based on the predetermined output number format. The most significant bits may be removed by saturation. In one configuration, the format of the output number is predetermined.

As previously discussed, increasing the multiplier-accumulator bit width may increase the complexity of hardware and/or software implementations. Furthermore, the increased multiplier-accumulator bit width may also increase memory usage. Thus, in some cases, the bit width of the multiplier-accumulator is reduced (e.g., limited) by rounding off bits, such as the least significant bits, when performing calculations.

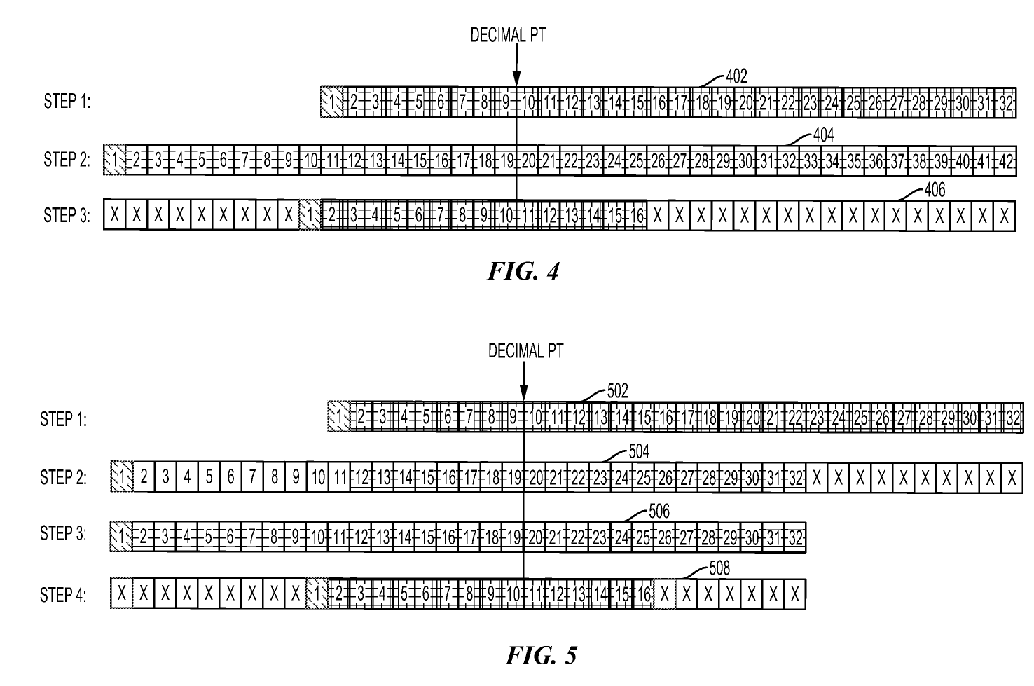

In one example, as shown in FIG. 5, the product w_{i,j}aⱼ 502 may be represented using 32 bits. Furthermore, in this example, the multiplier-accumulator is limited to 32 bits, still, as previously discussed, 42 bits are specified to determine the sum of the products. Therefore, in this example, to mitigate an overflow, at block 504, ten least significant bits are rounded off from the representation of the product w_{i,j}aⱼ. Additionally, as shown in block 504, the system may add ten most significant to the representation of the product w_{i,j}aⱼ. The most significant bits that are added may have a value of zero. Furthermore, adding the ten most significant bits is similar to performing a right shift of ten bits.

Additionally, in this example, by removing the ten least significant bits and adding the ten most significant bits, the sum of the products w_{i,j}aⱼ may be determined and stored in a 32 bit multiplier-accumulator 506. Finally, in this example, after determining and storing the sum of products in the multiplier-accumulator 506, a 16 bit output 508 is produced by rounding off seventeen least significant bits and removing nine most significant bits.

Still, rounding off a number of least significant bits to accommodate a limited bit width multiplier-accumulator may result in a quantization error (e.g., rounding off error). Thus, aspects of the present disclosure are directed to reducing the number of bits that are shifted to mitigate an overflow with a limited bit width multiplier-accumulator. That is, aspects of the present disclosure reduce the number of least significant bits that are removed from a product and the number of most significant bits that are added to a product.

As previously discussed, a number of bits (e.g., 16 bits) specified for an output is predetermined. Thus, based on the predetermined output, the system determines the number of bits that should be shifted so that the probability of an overflow is less than a threshold.

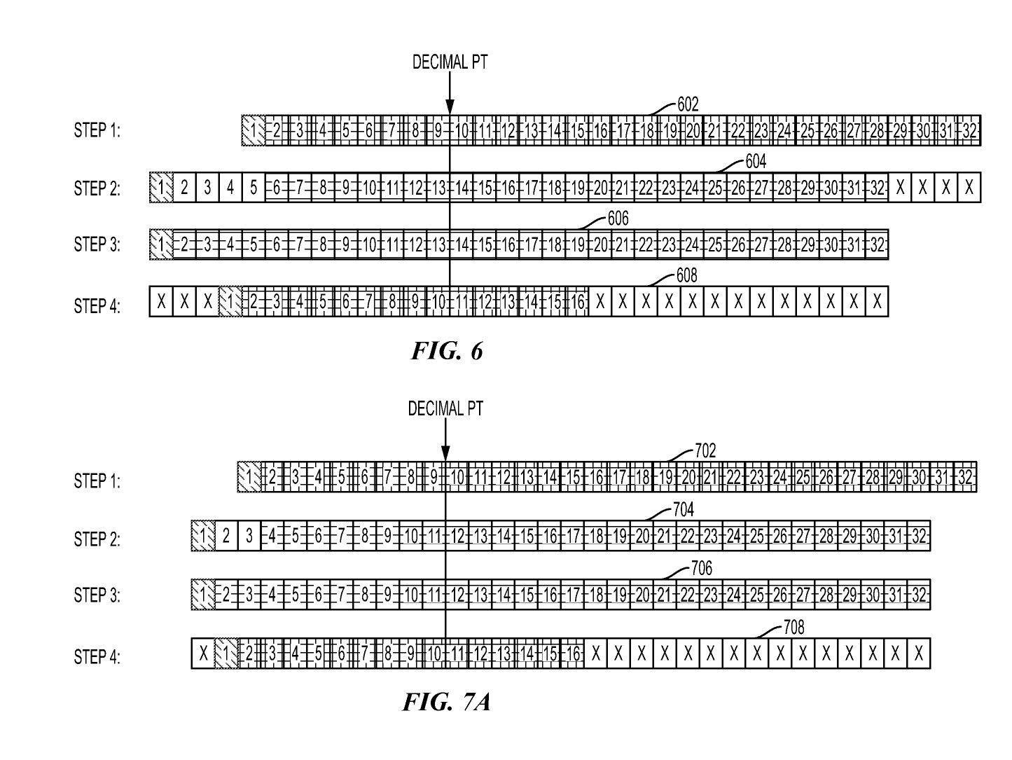

As shown in FIG. 6, the product w_{i,j}aⱼ 602 may be represented using 32 bits. Furthermore, in one configuration, based on the predetermined output, the system determines that four bits should be shifted so that the probability of an overflow is less than a threshold. In one example, as shown in FIG. 6, based on the predetermined output, at block 604, to mitigate an overflow, four least significant bits are rounded off from the representation of the product w_{i,j}aⱼ . Additionally, as shown in block 604, four most significant bits are added to the representation of the product w_{i,j}aⱼ. The most significant bits that are added may have a value of zero.

Additionally, as shown in FIG. 6, by removing the four least significant bits and adding the four most significant bits, the sum of the products w_{i,j}aⱼ may be determined and stored in a 32 bit multiplier-accumulator 606. Finally, in this example, after determining and storing the sum of products w_{i,j}aⱼ in the multiplier-accumulator 606, a 16 bit output 608 in the predetermined format of Q9.6 is produced by rounding off thirteen least significant bits and removing three most significant bits.

In another configuration, a number of terms (K) of the product w_{i,j}aⱼ may be added prior to performing the shift in bit position. In this configuration, the number of bit shift operations will be reduced by a factor of K. The K additions may be performed in a register, such as the register of the MAC, and the bit shift operations may be performed before writing to memory. According to aspects of the present disclosure, the number of bit shift operations refers to the number of shifts in bit positions for a fixed point number. Furthermore, a bit shift operation refers to a shift in bit position.

Specifically, in one configuration, the K terms may be added prior to performing the shift in bit position. Furthermore, the shift in bit position may then be performed on the sum of the K terms. Moreover, after performing the shift in bit position, another K terms may be added and another shift in bit position may be performed. The step of adding K terms and shifting a bit position may be performed until the desired output is obtained.

The value of K may be determined based on a probability of an overflow, such as the multiplier-accumulator overflow. That is, the value of K may be set to a specific value so that the probability of an overflow is less than or equal to a threshold. Additionally, or alternatively, the value of K may be derived based on performance and/or other factors, such as a size of a cache. For example, K may be based on a balance between reducing the number of bit shift operations and preventing the overflow error.

In another configuration, a number format is changed to reduce the number of shifts in bit position or avoid a shift in bit position. That is, a number format of input activations and/or number format of weights may be modified to reduce the number of shifts in bit position or avoid a shift in bit position. In this configuration, when the number of integer bits in a product w_{i,j}^{(l+1)} and an output activation aⱼ^{(l)} are substantially similar, a number of shifts in bit position is reduced or avoided by modifying the number format of weights w_{i,j}^{(l+1)} and/or input activations aⱼ^{(l)} such that a product w_{i,j}^{(l+1)}aⱼ^{(l)} is specified to have a number of integer bits that is equal to or greater than that of the output activation aᵢ^{(l+1)}.

For example, the weight w_{i,j} may have a format of Q4.11, the input activation aⱼ may have a format of Q3.12, and the output may have a format of Q9.6. Based on the baseline design, a product w_{i,j}aⱼ may have a format of Q8.23. In this example, the number format is not modified. Thus, because eight is less than nine (e.g., Q8.23<Q9.6), a bit shift operation may be specified to produce an output of format Q9.6.

In another example, the format of the input activation a₁ is changed from Q3.12 to Q5.10, such that the product w_{i,j}aⱼ may have a format of Q10.21. Thus, because ten is greater than nine (e.g., Q10.21>Q9.6), a shift in bit position may be avoided to produce an output of format Q9.6. According to aspects of the present disclosure, the number format may be modified when the probability of an overflow is equal to or less than a threshold. Of course, aspects of the presented disclosure are not limited to only modifying the format of input activations aⱼ, aspects of the present disclosure are also contemplated for modifying the format of the weights w_{i,j}, the activations aⱼ, and/or any other type of number.

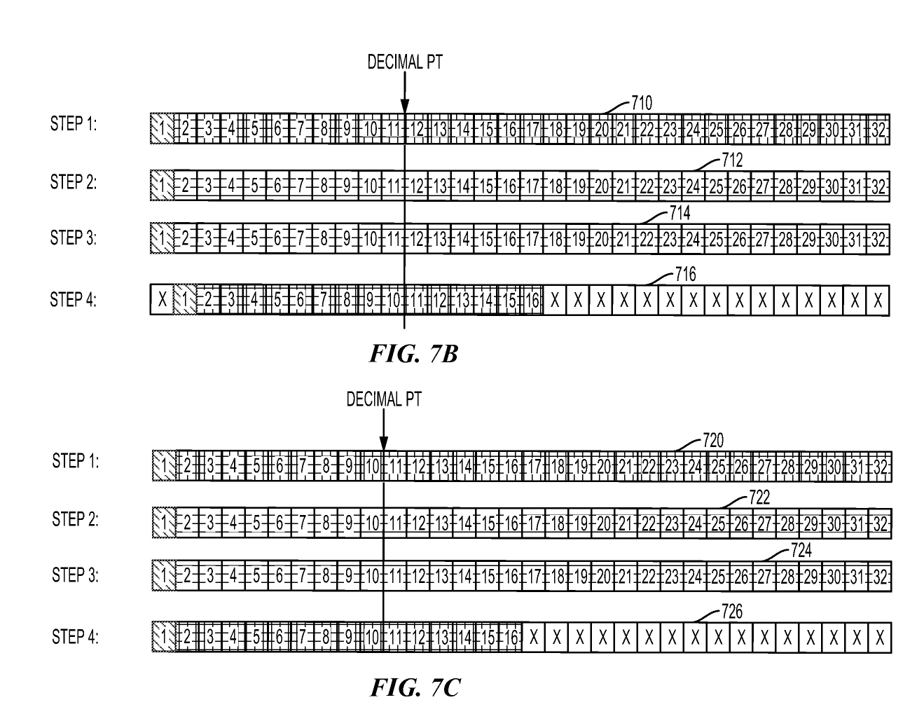

FIG. 7A illustrates an example of determining a sum of products without modifying number formats. As shown in FIG. 7A the product w_{i,j}aⱼ 702 may be represented using 32 bits. Furthermore, as previously discussed, based on the predetermined output, the system determines that two bits should be shifted so that the probability of an overflow is less than a threshold. In one example, as shown in FIG. 7A, based on the predetermined output, at block 704, to mitigate an overflow, two least significant bits are rounded off from the representation of the product w_{i,j}aⱼ. Additionally, as shown in block 704, two most significant bits are added to the representation of the product w_{i,j}aⱼ.

Additionally, as shown in FIG. 7A, by removing the two least significant bits and adding the two most significant bits, the sum of the products may be determined and stored in a 32 bit multiplier-accumulator 706. Finally, in this example, after determining and storing the sum of products w_{i,j}aⱼ in the multiplier-accumulator 706, a 16 bit output 708 in the predetermined format of Q9.6 is produced by rounding off fifteen least significant bits and removing one most significant bit.

FIG. 7B illustrates an example of determining a sum of products by modifying number formats. As shown in FIG. 7B the product w_{i,j}aⱼ 710 may be represented using 32 bits. Furthermore, as previously discussed, a number format of input activations aⱼ and/or number format of weights w_{i,j} may be modified to reduce a number of shifts in bit position or avoid shift in bit position. In the present example, as shown in FIG. 7B, the number format of input activations aⱼ and/or number format of weights w_{i,j} may be modified so that the product 710 has a number format of Q10.21. As previously discussed, because ten is greater than nine (e.g., Q10.21>Q9.6), a shift in bit position may be avoided to produce an output having a format of Q9.6. Thus, in the present example, the shift in bit position may be avoided. Therefore, in contrast to the example of FIG. 7A, in the present example, bit shift operations are not specified at block 712.

Furthermore, as shown in FIG. 7B, the sum of the products may be determined and stored in a 32 bit multiplier-accumulator 714. Finally, in this example, after determining and storing the sum of products w_{i,j}aⱼ in the multiplier-accumulator 714, a 16 bit output 716 in the predetermined format of Q9.6 is produced by rounding off fifteen least significant bits and removing one most significant bit.

In another configuration, when modifying the number format, a number format is selected so that most significant bits are not removed to achieve the predetermined format of Q9.6.

FIG. 7C illustrates an example of determining a sum of products by modifying number formats. As shown in FIG. 7C the product w_{i,j}aⱼ 720 may be represented using 32 bits. Furthermore, as previously discussed, a number format of input activations aⱼ and/or number format of weights w_{i,j} may be modified to reduce a number of shifts in bit position or avoid a shift in bit position. In the present example, as shown in FIG. 7C, the number format of input activations aⱼ and/or number format of weights w_{i,j} may be modified so that the product 720 has a number format of Q9.22. In the present example, because the number of integers of the current number format (e.g., Q9.22) are equal to the number of integers of the predetermined output (e.g., Q9.6), shifts in bit position may be avoided to produce an output having a format of Q9.6. Thus, in contrast to the example of FIG. 7A, in the present example, bit shift operations are not specified at block 722.

Furthermore, as shown in FIG. 7C the sum of the products w_{i,j}aⱼ may be determined and stored in a 32 bit multiplier-accumulator 724. Finally, in this example, after determining and storing the sum of products w_{i,j}aⱼ in the multiplier-accumulator 724, a 16 bit output 726 in the predetermined format of Q9.6 is produced by rounding off sixteen least significant bits. Furthermore, in the present example, the most significant bits are not removed because the number of integers of the current number format (e.g., Q9.22) is equal to the number of integers of the predetermined output (e.g., Q9.6).

As previously discussed, the number format of input activations aⱼ and/or weights w_{i,j} may be modified to increase the number of integer bits (e.g., decrease the number of fractional bits) of input activations aⱼ and/or weights w_{i,j}. As a result of the modification, the number of integer bits of the product w_{i,j}aⱼ is increased.

Still, in some cases, reducing the number of fractional bits may reduce the resolution of the fixed point representation and may reduce performance. Thus, in some cases, it may be desirable to measure performance sensitivity as a function of the change of quantizer resolution to determine the number of fractional bits to remove from input activations aⱼ and/or weights w_{i,j}.

In an exemplary network, when input activations a_{i,j} and weights w_{i,j} have the same bit width, the system performance may have an increased sensitivity to a change of resolution of weights w_{i,j}. Furthermore, in some cases, when input activations aⱼ and weights w_{i,j} have the same bit width it may be desirable to remove one fractional bit. That is, one fractional bit may be removed from input activations a_{i,j} to reduce the impact on performance.

In one configuration, the number of integer bits in the representations of input activations aⱼ and/or weights w_{i,j} is increased. Furthermore, the increase in the number of integer bits may be combined with adding a number of terms (K) of w_{i,j}aⱼ before performing the bit-shift. In this configuration, the number of additions (K) that can be performed before a bit shift operation is increased. Thus, increasing the number of integer bits for the input activations aⱼ and/or weights w_{i,j} may increase the dynamic range of the product w_{i,j}aⱼ, and may thereby reduce the likelihood of overflow.

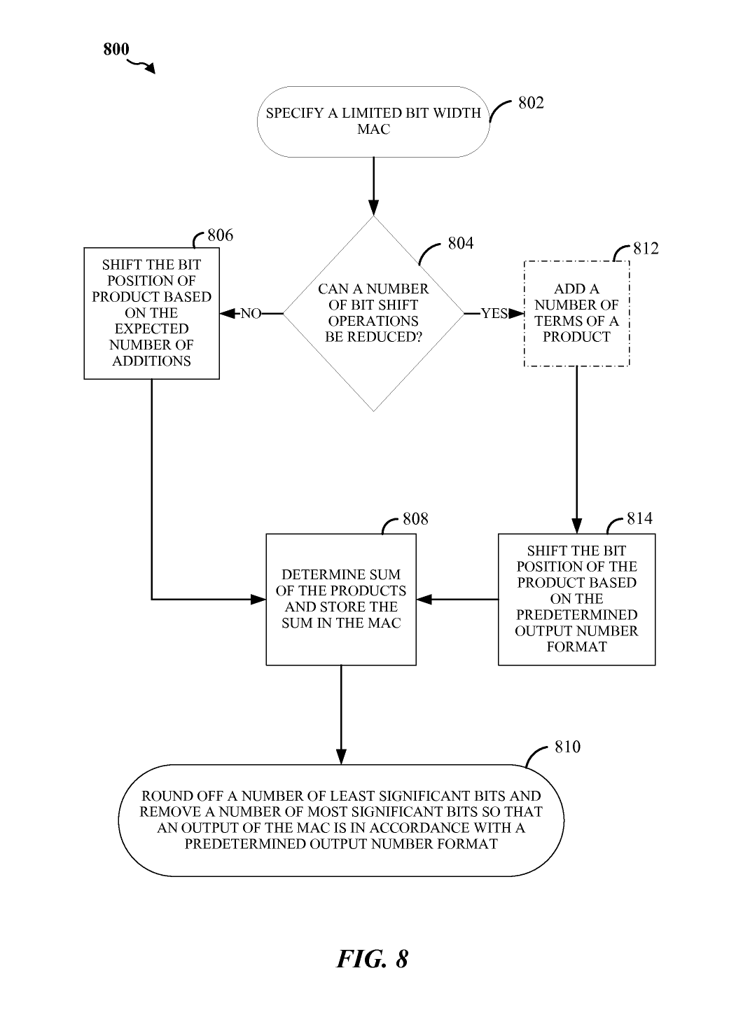

FIG. 8 illustrates a method 800 for reducing computation complexity for a fixed point machine learning network (e.g., neural network) operating in a system having a limited bit width in a multiplier-accumulator. In block 802, a limited bit width multiplier-accumulator is specified. Furthermore, in block 804, the network determines if a number of bit shift operations can be reduced while having the probability of an overflow being less than or equal to a threshold. If the number of bit shift operations cannot be reduced, at block 806, a bit position of the product is shifted based on the expected number of additions. In block 806, the number of bit shift operations is a first number. After performing the shift in bit position, the sum of the products is determined and stored in the multiplier-accumulator (block 808). Finally, at block 810, a number of least significant bits is rounded off and a number of most significant bits is removed so that an output of the multiplier-accumulator is in accordance with a predetermined output number format.

Alternatively, if the number of bit shift operations can be reduced (804:YES), at block 814 a bit position of the product is shifted with the number of shift in bit position being based on the predetermined output number format. In block 814, the number of bit shift operations is a second number that is less than the first number. Optionally, in one configuration, prior to performing a shift in bit position, at block 812, a number of terms (K) of a product are added. In one configuration (not shown), the adding of terms (block 812) and bit shift operations (block 814) may be continuously performed until all of the products are added.

After performing the shift in bit position, the sum of the products is determined and stored in the multiplier-accumulator at block 808. Finally, at block 810, a number of least significant bits is rounded off and a number of most significant bits is removed so that an output of the multiplier-accumulator is in accordance with a predetermined output number format.

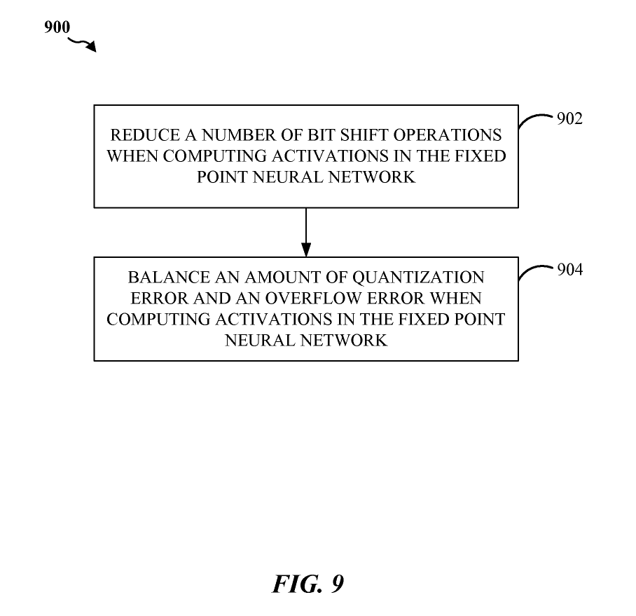

FIG. 9 illustrates a method 900 for reducing computational complexity for a fixed point machine learning network (e.g., a neural network) operating in a system having a limited bit width in a multiplier-accumulator. In block 902, the network reduces a number of bit shift operations when computing activations in the network. Furthermore, in block 904, the network balances a quantization error and an overflow error when computing activations in the network.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of reducing computational complexity for a fixed point neural network operating in a system having a limited bit width in a multiplier-accumulator (MAC), comprising:
reducing a number of bit shift operations when computing activations in the fixed point neural network; and
balancing an amount of quantization error and an overflow error when computing activations in the fixed point neural network.

2. The method of claim 1, in which the balancing comprises reducing the number of bit shift operations before an intermediate addition step to balance a likelihood of overflow and the amount of quantization error.

3. The method of claim 1, further comprising adding a number (K) of terms while computing activations before performing a bit shift operation.

4. The method of claim 3, in which the number is based at least in part on a balance between decreasing bit shift operations and preventing the overflow error.

5. The method of claim 3, in which the adding occurs in a register of the MAC and the bit shift operation occurs before writing to memory.

6. The method of claim 3, further comprising modifying a number format of input activations and/or a number format of weights before adding the number (K) of terms to reduce a likelihood of overflow.

7. The method of claim 1, further comprising modifying a number format of input activations and/or a number format of weights to reduce the number of bit shift operations to zero.

8. The method of claim 7, in which the modifying further comprises increasing a number of integer bits and/or decreasing a number of fractional bits in a first number format of the input activations and/or a second number format of the weights.

9. An apparatus for reducing computational complexity for a fixed point neural network operating in a system having a limited bit width in a multiplier-accumulator (MAC), the apparatus comprising:
means for reducing a number of bit shift operations when computing activations in the fixed point neural network; and
means for balancing an amount of quantization error and an overflow error when computing activations in the fixed point neural network.

10. The apparatus of claim 9, in which the means for balancing comprises means for reducing the number of bit shift operations before an intermediate addition step to balance a likelihood of overflow and the amount of quantization error.

11. The apparatus of claim 9, further comprising means for adding a number (K) of terms while computing activations before performing a bit shift operation.

12. The apparatus of claim 11, in which the number is based at least in part on a balance between decreasing bit shift operations and preventing the overflow error.

13. The apparatus of claim 11, in which the adding occurs in a register of the MAC and the bit shift operation occurs before writing to memory.

14. The apparatus of claim 11, further comprising means for modifying a number format of input activations and/or a number format of weights before adding the number (K) of terms to reduce a likelihood of overflow.

15. The apparatus of claim 9, further comprising means for modifying a number format of input activations and/or a number format of weights to reduce the number of bit shift operations to zero.

16. The apparatus of claim 15, further comprising means for increasing a number of integer bits and/or decreasing a number of fractional bits in a first number format of the input activations and/or a second number format of the weights.

17. An apparatus for reducing computational complexity for a fixed point neural network operating in a system having a limited bit width in a multiplier-accumulator (MAC), the apparatus comprising:
a memory unit; and
at least one processor coupled to the memory unit, the at least one processor configured:
to reduce a number of bit shift operations when computing activations in the fixed point neural network; and
to balance an amount of quantization error and an overflow error when computing activations in the fixed point neural network.

18. The apparatus of claim 17, in which the at least one processor is further configured to reduce the number of bit shift operations before an intermediate addition step to balance a likelihood of overflow and the amount of quantization error.

19. The apparatus of claim 17, in which the at least one processor is further configured to add a number (K) of terms while computing activations before performing a bit shift operation.

20. The apparatus of claim 19, in which the number is based at least in part on a balance between decreasing bit shift operations and preventing the overflow error.

21. The apparatus of claim 19, in which the adding occurs in a register of the MAC and the bit shift operation occurs before writing to memory.

22. The apparatus of claim 19, in which the at least one processor is further configured to modify a number format of input activations and/or a number format of weights before adding the number (K) of terms to reduce a likelihood of overflow.

23. The apparatus of claim 17, in which the at least one processor is further configured to modify a number format of input activations and/or a number format of weights to reduce the number of bit shift operations to zero.

24. The apparatus of claim 23, in which the at least one processor is further configured to increase a number of integer bits and/or decreasing a number of fractional bits in a first number format of the input activations and/or a second number format of the weights.

25. A non-transitory computer-readable medium for a fixed point neural network operating in a system having a limited bit width in a multiplier-accumulator (MAC), the non-transitory computer-readable medium having program code recorded thereon, the program code being executed by a processor and comprising:
program code to reduce a number of bit shift operations when computing activations in the fixed point neural network; and
program code to balance an amount of quantization error and an overflow error when computing activations in the fixed point neural network.

26. The non-transitory computer-readable medium of claim 25, further comprising program code to decrease the number of bit shift operations before an intermediate addition step to balance a likelihood of overflow and the amount of quantization error.

27. The non-transitory computer-readable medium of claim 25, further comprising program code to add a number (K) of terms while computing activations before performing a bit shift operation.

28. The non-transitory computer-readable medium of claim 27, in which the number is based at least in part on a balance between decreasing bit shift operations and preventing the overflow error.

29. The non-transitory computer-readable medium of claim 27, in which the adding occurs in a register of the MAC and the bit shift operation occurs before writing to memory.

30. The non-transitory computer-readable medium of claim 27, further comprising program code to modify a number format of input activations and/or a number format of weights before adding the number (K) of terms to reduce a likelihood of overflow.
